(19) United States
(12) Patent Application Publication
(10) Pub. No.: US 2010/0178412 A1
(43) Pub. Date: Jul. 15, 2010

(54) PRESERVED OLIVE PASTE

(76) Inventors: Amador Márquez Gómez, Zaragoza (ES); Telm Costa Escoda, Cambrils (ES)

Correspondence Address: IP Patent Docketing;K&L GATES LLP, 599 Lexington Avenue, 33rd Floor, New York, NY, 10022-6030, US

(21) Appl. No.: 12/594,793

(22) PCT Filed: Dec. 14, 2007
(86) PCT No.: PCT/EP07/63977

§ 371 Date: Mar. 16, 2010

Related U.S. Application Data
(60) Provisional application No. 60/924,038, filed on Apr. 27, 2007.

(30) Foreign Application Priority Data
Apr. 4, 2007 (EP) 07380090.6

(51) Int. Cl. A23D 7/06; A23D 9/06

(52) U.S. Cl. 426/601; 426/524; 426/393; 426/615; 426/417

(57) ABSTRACT

The present disclosure relates to a method for the preservation of olive oil that consists of freezing and optionally vacuum-packing the paste obtained from olive grinding. Furthermore, olive paste obtained through the preservation method, a procedure to obtain olive oil, and the olive oil obtained through this method, are disclosed.

### CROSS REFERENCE TO RELATED APPLICATIONS AND PRIORITY CLAIM

This application claims the benefit under 35 U.S.C. §371 to PCT/EP2007/063977 filed Dec. 14, 2007, which claims the benefit of European Patent Application No. 07380090.6 filed Apr. 4, 2007 and U.S. Provisional Application No. 60/924,038 filed Apr. 27, 2007. The entire disclosures of both applications are incorporated herein by reference thereto.

### BACKGROUND

1. Technical Field

The present disclosure relates to a method for the preservation of olive oil that consists of freezing and optionally vacuum-packing the paste obtained from olive grinding. Furthermore, olive paste obtained through the preservation method, a procedure to obtain olive oil, and the olive oil obtained through this method, are disclosed.

2. Background

Olive oil is extracted from olives (Olea europaea L. sensu lato), which are the fruit of the olive tree. The composition of this fruit at the time of harvesting varies greatly, depending on the variety of olives, the soil, the weather and the crop. Olive oil is a live product, and therefore special care is required when it is processed and stored. If the oil is processed or stored in deficient conditions, it goes through certain changes that alter it (rancidity, aroma, color, etc).

In order to prevent the negative changes from taking place during the storage, olive oil is currently stored in mills under the following conditions:
Built of waterproof material in order to allow them to be washed before they are filled with new oil.
They are made of inert material which cannot react against the oil.
They do not absorb odors.
They do not contain materials that speed up the rancidity process.
They do not absorb light and humidity.
They are kept at constant temperature, if possible, 15° C., due to the fact that higher temperatures encourage rancidness, and low temperatures cause the oil to get blurry.

However, this kind of storage is expensive and can lead to the accumulation of a layer of non-soluble material during storage that can ferment and cause unpleasant odors in the olive oil. In order to avoid this, the oil must be strained, a treatment that must sometimes be repeated several times before bottling. During these procedures, the olive oil must be exposed to the air as briefly as possible in order to avoid oxidation or rancidity. Also, the volatile compounds that develop during extraction become less dominant during oil storage with the emergence of volatile compounds from chemical oxidation.

Furthermore, in order to prevent the olive oil from losing its excellent properties, it must not be stored for long periods of time. If this is inevitable, it must be stored in a place where there is no excessive heat or humidity, far from the light and from intense odors, due to the fact that the oil has the peculiar feature of absorbing intense odors fast, and these odors may be harmful to the features of this liquid.

Most of the abovementioned changes that the olive oil goes through during storage depend on enzyme reactions; these reactions not only cause adverse effects in the flavor and aromatic profiles but can also cause positive changes that could produce qualitative and quantitative differences in quality. Some of the enzymes or enzymes pathways that have a positive influence on the olive oil organoleptic characteristics are:
The lipoxygenase (LOX) pathway: a cascade of enzymes that can oxidise free polyunsaturated fatty acids to C₅ and C₆ volatile compounds responsible for the virgin olive oil sensory attributes (Angerosa et al., 1999), and the olive flavor (Sabatini & Marsilio, 2007).
β-Glucosidases: enzymes responsible for the hydrolization of oleuropein and ligstroside to relative aglycons, which are more soluble in oil and, hence, more separable from olive paste than the glucosidic forms, that helps increasing the concentration of secoiridoids compounds on olive oil (natural antioxidants), contributing to stability, flavour and the nutritional features of virgin olive oil.
Hydroperoxide lyases (HPL): Enzyme responsible for catalyzing the cleavage of fatty acid hydroperoxides, producing volatile aldehydes and oxoacids. The enzyme isoform that uses 13-hydroperoxides produces C₆ aldehydes responsible for the green aroma of olive oil.
Alcohol dehydrogenase (ADH): Enzyme responsible for catalyzing the reversible reduction of aliphatic aldehydes to alcohols contributing to the aroma of vegetable products.
Alcohol acetyl transferase (AAT): Enzyme responsible for catalysing the formation of acetate esters through acetyl-CoA derivatives.

On the other hand, some of the enzymes that have a negative influence on the olive oil organoleptic characteristics are polyphenoloxidase (PPO) and peroxidise (POD). These enzymes are responsible for the oxidation of phenolic compounds (i.e., secoiridoids), resulting in a reduced phenolic concentration of oil. This oxidation reduces the organoleptic and sensitive characteristics, oxidative stability and nutritional quality of virgin olive oil (Vierhuis et al. 2001).

In this regard, and in order to preserve high quality virgin olive oil, various processes have been proposed in the state of the art. The general criteria for preserving vegetable material is to apply very low temperatures or dehydratation in order to reduce the enzymatic activity, thus increasing the stability of the material.

Processes such as those that combine malaxation under low oxygen levels, follow by an immediate freezing of the olive paste using liquid nitrogen and high pressure (Migliorini et al. 2006), or processes consisting of drying under vacuum at temperatures less or equal to −80° C., or at reduced pressure of 10⁻³-10⁻¹ bar the olive material after the malaxation process and pressing it in order to obtain a lipid composition containing lipid-soluble and water-soluble antioxidants, are known in the art. Then antioxidants are then use to protect the food and cosmetic products from oxidation.

However, the use of liquid nitrogen or the process of dehydrating by drying the olive material results in a complete inactivation of the enzymatic activity, stopping the positive enzymes from releasing the phenols, with the subsequent decrease of the organoleptic and nutritional characteristics and the potential beneficial health effects of olive oil polyphenols (Visioli & Galli, 1998).

Consequently, there is still a need to develop a simple and commercial process to preserve high quality virgin olive oil for long periods of time.

### BRIEF DESCRIPTION OF THE FIGURES

FIG. 1 shows the evolution of the Peroxide Index on different controls in Arbequina (1: initial control; 2: control 1 month; 3: control 3 months; 4: control 6 months; 5: control 12 months).

FIG. 2 shows the evolution of acidity on different controls in Arbequina (1: initial control; 2: control 1 month; 3: control 3 months; 4: control 6 months; 5: control 12 months).

FIG. 3 shows the evolution of the Peroxide Index on different controls in Piqual (1: initial control; 2: control 1 month; 3: control 3 months; 4: control 6 months).

FIG. 4 shows the evolution of the K₂₇₀ Index in Arbequina on different controls (1: initial control; 2: control 1 month; 3: control 3 months; 4: control 6 months; 5: control 12 months).

FIG. 5 shows the evolution of the K₂₃₂ Index in Arbequina on different controls (1: initial control; 2: control 1 month; 3: control 3 months; 4: control 6 months; 5: control 12 months).

### DETAILED DESCRIPTION OF THE PREFERRED EMBODIMENTS

The present disclosure relates to a method for the preservation of olive oil by directly freezing at a temperature between about 0° C. and about −40° C., and optionally vacuum-packing, the paste directly obtained from olive grinding. The paste use in this method is obtained by grinding olives to obtain a homogeneous paste which is then directly frozen. It is not the paste obtained after the malaxation process, which in itself implies stiffing the paste in order to obtain a continuous oleous phase, which facilitates the separation of the oil from the rest of the oil components during the stage previous to the separation where the paste can be slightly heated in order to provoke a reduction of the oil viscosity and facilitate the formation of the oleous phase and its separation. The phase separation that occurs during the malaxation process increases the possibilities that an alteration of the organoleptic and physicochemical properties of the oil is produced. Thus, the preserved and frozen olive paste of the method described herein results in an olive oil with surprisingly superior analytical and sensory characteristics in comparison with other preservation methods.

Olive oil is a product with extremely complex physico-chemical and organoleptic features. The preservation of these features is essential for the product to keep those properties (taste, odor, etc), which make it a vital component of all balanced diets.

Therefore, the proper preservation of olive oil is essential for maintaining the oils nutritious and organoleptic properties. The olive oil preservation method described herein makes it possible to obtain high quality olive oil easily and quickly from the preserved and frozen olive paste. The paste results in an olive oil with physico-chemical and organoleptic features higher than those from the oil obtained through other preservation methods, and therefore it allows obtaining excellent quality virgin olive oil for longer periods. Additionally, the preserved frozen olive paste makes it possible to obtain extra virgin olive oil instantaneously as needed, during long periods of time. Thus, any person in any part of the world would have access to an olive oil obtained at the same time of consumption, thereby preserving its physico-chemical and organoleptic features.

Freezing of vegetable material usually takes place with the formation of extra-cellular and intra-cellular water crystals, which could break the cell walls. Conventional wisdom accepts that the quicker the temperature drops during freezing, the more rapidly freezing occurs, and the better preserved is the vegetable material. That is because enzymes are inactivated, and the water crystallization takes place with the formation of small crystals that do not or scarcely break the cell membranes.

The oil in the olives is contained in the mesocarp vacuoles, in a particular type of vacuole called a lipovacuole. Enzymes of olives have been detected in different localizations, mainly on the mesocarp, and in the cytoplasm, lipid bodies and chloroplast.

Oleic acid, the main compound of the olive oil (about 70-80% in weight), has a cryoscopic melting point of about −10° C. at conventional pressures and crystallizes more slowly than water due to the fact that water has a melting point of about 0° C. at conventional pressures. Thus, when slowly freezing at a temperature between about 0° C. and about 22° C., the olive paste directly obtained from olive grinding, we are putting into contact those enzymes liberated during the grinding process and those liberated by the rupture of cell membranes by the large extra-cellular and intra-cellular water crystals formed during the freezing process with the oil drops. Thus, accelerating the oxidative process, but also producing some volatile compounds necessary for the sensorial features that indicate the quality of the virgin olive oil. Surprisingly, this cell wall degradation during the mechanical grinding of the olives and the formation of large extra-cellular and intra-cellular water crystals increases the concentration of enzymes like β-Glucosidases and the interval of time in which they act, resulting in a release of phenolic compounds in the oil thus increasing its oxidative stability.

Thus, the present preservation method results in an olive oil enriched on phenolic compounds, due to, among other things, the prolonged contact of enzymes responsible for the hydrolysis of oleuropein and ligstroside to relative aglycons, which are more soluble in oil and, hence, more separable from olive paste than the glucosidic forms.

In order to demonstrate the olive oil quality obtained from the preserved frozen olive paste described herein, several operational controls have been performed on two different varieties of olives (Arbequina and Picual). In order to do that, studies have been conducted in comparison with other forms of oil preservation in different periods of time. Other forms of preservation used were: refrigerated or frozen preserved olives, olive oil preserved at ambient temperature, and oil obtained from the preserved frozen olive paste described herein. Those experiments are shown in examples 2 and 3 herein.

Through these experiments, it was proven (see Table II) that the acidity of the oils obtained has been kept stable during the first and third month, with a value of approximately 0.20, except for the oil obtained from preserved refrigerated olives, which had a high value of 0.67 on the first month and 1.21 on the third month. Therefore, it can be determined that the acidity of the oil obtained from preserved refrigerated olives loses the property of extra virgin oil after the third month of preservation. Values determined during the sixth month and one year, surprisingly point out that the acidity of the oils obtained from the frozen olive paste described herein, is well below that of the other preservation methods, thus supporting the fact that the current preservation method preserves the physicochemical and organoleptic quality of the oil.

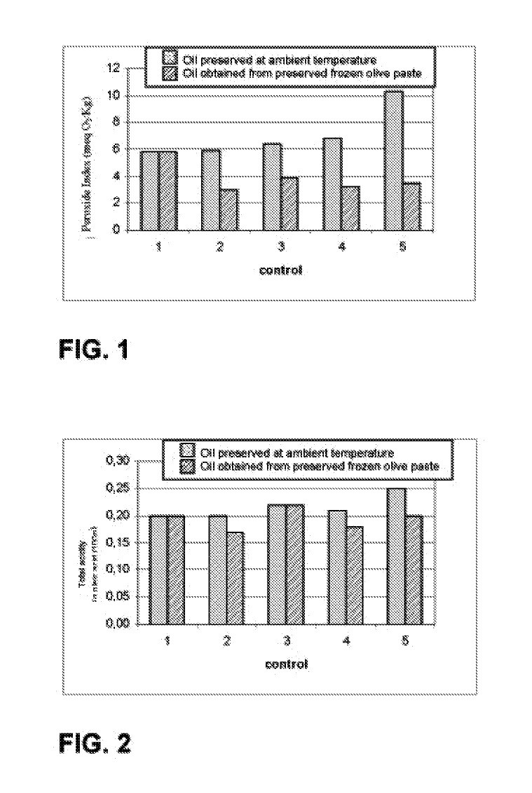

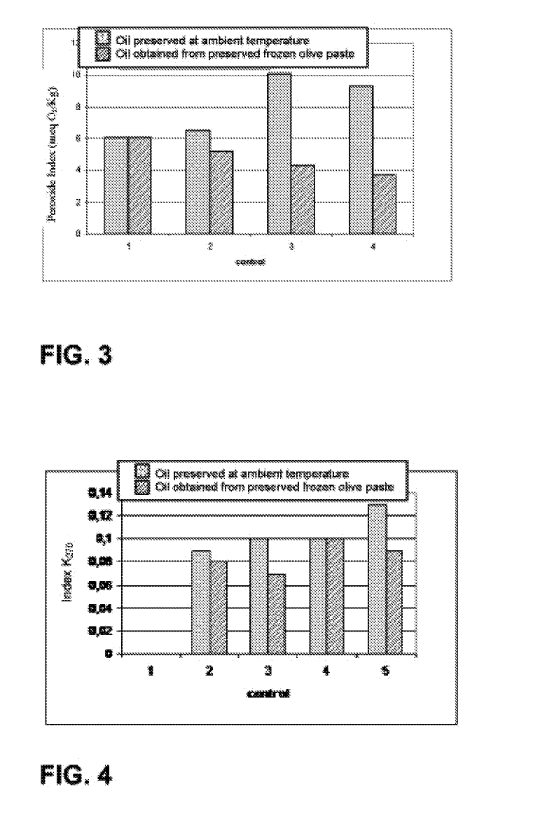

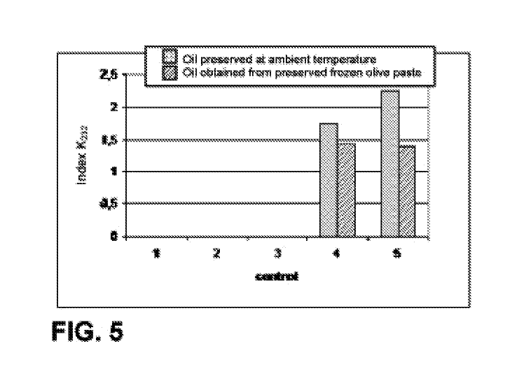

It is observed that the peroxide index (PI) of the different preserved oils (see Table II) has lower values than usual, taking into account that the usual range of oils obtained from the Arbequina is between 7 and 11 mEq/Kg. However the PI of the olive oil preserved at ambient temperature shows a clear tendency to increase as time goes by. It is only necessary to observe the PI values obtained on the third month, where it is also observed that there is a significant difference between the preserved frozen paste olive oil with a PI of 3.9 and the oil preserved at ambient temperature with a PI of 6.4. However, the PI values obtained on the sixth month and one year for the oil obtained from the preserved frozen olive oil paste were inferior to the values for the third month (Table II, FIG. 1 and FIG. 2). That supports the previously stated hypothesis that there might be an increase in the phenolic concentration due to the way in which the paste was preserved.

The results shown on Tables III and IV demonstrate how refrigerated and frozen preserved olives do not render olive oils with proper sensory characteristics, as some defects have appeared in them. It can also be seen that there is a worse compensation of oil preserved at ambient temperature in the third month in comparison with the oil obtained from the preserved frozen olive paste described herein.

As for Tables V and VI, a clearly positive tendency can be observed regarding the oil obtained from the preserved frozen olive paste Picual, which equals that corresponding to Arbequina.

Therefore, a first example embodiment of the disclosure is a method of olive oil preservation, which comprises freezing at a temperature of between about 0° C. and about −40° C., and optionally vacuum-packing, directly the paste obtained from ground olives, preferably as soon as the said paste has been obtained or within a period of time that allows the obtained olive oil to maintain the proper physical-chemical and organoleptic features that make it suitable for human or animal consumption.

The preservation method may be applied to the obtained paste from the grinding of any kind of olives, preferably but not limited to the following varieties: Picual, Hojiblanca, Lechin, Picudo, Arbequina, Cornicabra, Verdial or Empeltre, and more preferably to any of the varieties shown on Table VII, and even more preferably to any of the 262 varieties, which are grouped in four categories: main, secondary, disperse and local, all of which are grown in Spain.

TABLE VII

| Name | Description/Origin |
|---|---|
| Picual o “marteña” | Ellipsoidal shape, but with a peak in the apex (pole |
| | opposite to the peduncle) that gives the name to this |
| | variety. It is the most common variety grown in Spain, |
| | especially in Andalucia. |
| Hojiblanca | Fruit, almost spherical, Andalucia |
| Lechin | Medium or small fruit with round apex |
| | Westem Andalucia |
| Arbequina | Oval, short and small fruit, Cataluña and Ebro Valley |
| Picudo | Characterized nipple in the apex. It's also called |
| | “carrasqueña”. It may be used as dressing |
| | (double aptitude,) |
| Goat's horn or | More prolonged ellipsoid shape than the picual, somehow |
| “cornezuelo: | deformed (goat's horn) Castilla - La Mancha |
| Verdial | Shape similar to that of a small lemon. Extremadura and |
| | Andalucia |
| Empeltre | Prolonged, somewhat asymmetric fruit, blackish when |
| | matured. Ebro Valley |
| Slanquets | Small fruit with a nipple in the apex. Valencia and Alicante. |
| Farga | Small or medium prolonged fruit, slightly convex on one |
| | side and flat on the other side. North of Valencia |
| | Community, Tarragona and Teruel. |
| Chamomile “cacereña” | Green fruit that turns purple and that, due to its shape, it |
| | reminds of a small apple. Caceres and Salamanca. |
| Morisca | Thick fruit, somewhat prolonged, Badajoz. |
| Aloreña | Medium fruit with round apex. Mixed aptitude, Malaga. |
| Morrut | Tarragona y Castellón |
| Seville | Tarragona y Castellón |
| Castillan | Guadalajara y Cuenca |
| Villalonga | Valencia |
| Changlot | Valencia |
| Alfafara | Valencia |
| Chamomile | The fruit essentially used for table olives. It comes from |
| | “Dos Hermanas” (Seville) and is mainly grown there. |
| Gordal | Another typical table olive grown mainly in Seville. |

In a preferred embodiment, the preservation method is carried out through the washing of the olives before treatment and the elimination of vegetable parts such as leaves and vegetable remains. Then, the paste is prepared by grinding the olives in order to break the intermediate layer vacuoles (pulp) of the olive which have oil drops inside, and thus allow its extraction. This treatment is performed using different types of mills.

The paste thus obtained can be vacuum packing for example by freezing in low permeability bags or by vacuum-packing in order to preserve its properties.

In another preferred embodiment, the preserved frozen olive paste is frozen at a temperature between about 0° C. and about −40° C. In a more preferred embodiment, the preserved frozen olive paste is frozen at a temperature between about 0° C. and about −22° C. or between about −5° C. and about −18° C. In an even more preferred embodiment, the preserved frozen olive paste is frozen at a temperature between about −5° C. and about −15° C. or between about −7° C. and about −10° C.

A second example embodiment is the preserved frozen olive paste obtained by the preservation method hereof—vacuum-packed or not—where that paste might be given all kinds of shapes and sizes, which makes it suitable for industrial or home marketing.

The preserved frozen olive paste may also include any kind of substance that improves its physical-chemical and organoleptic features or its state of preservation. For example, this may included but is not limited to anti-oxidants, fragrance, colorings, preservatives, spices, etc.

A third example embodiment is the procedure through which the oil is obtained from the preserved frozen—vacuum-packed or not—olive paste which comprises at least the following: a) emulsion or stirring of the paste and b) decanting or centrifuging the emulsion. Optionally, the oil thus obtained may be filtered.

In a preferred embodiment, the method of obtaining of olive oil through the paste described herein may use the following treatments:
Stirring of the paste (malaxation)

This procedure consists of stirring the paste in order to obtain a continuous oleous phase, which facilitates the separation of the oil from the rest of the oil components during the stage previous to the separation where the paste can be slightly heated in order to provoke a reduction of the oil viscosity and facilitate the formation of the oleous phase and its separation. However, the temperature should not be higher than 30° C. during the stirring process in order to minimize the oxidation processes and the loss of volatile components by means of evaporation, thus making it possible to obtain quality oils.

The stirring time must be enough for the solid, aqueous and oleous phases to get grouped and obtain a uniform mass temperature. Excessive stirring is not recommended as this could provoke a reduction of the content of polyphenols in the oil and the loss of fragrance. The stirring time is usually in the range of 10-60 minutes, preferably between 30-45 minutes.

This procedure may also take place through the addition of hot water, approximately 300 mL per kg of paste. In this case the procedure consists of stirring the paste for 10-30 minutes without adding water, trying to keep the temperature stable and later, boiling water is added and the stirring goes on for another 5-15 minutes.
Centrifugation of the paste

The previous extraction of oil is achieved through centrifugation. At this stage, the solid phase (composed of skin, pulp and olive bones (pits)) separates from the liquid phase formed by the olive paste and which is collected in a decanter.
Decanting of the oil

The liquid phase obtained during the centrifugation stage is separated into two phases: oil and aqueous phase (alpecin) through decanting. The decanting time must be enough to produce the separation of phases and be able to collect the oil from the upper part and bottle it. The usual decanting time is between 5-15 minutes.

In a preferred embodiment, a stage could be added between the stirring and the emulsion, which would include pressing of the emulsion in order to separate the solid part from the liquid part.

In a preferred embodiment of the oil obtaining method, the paste might turn into an emulsion with any other kind of substance and/or food, such as, without restriction, fruit, fungi, algae, in order to later press the emulsion, centrifuge it and decant it in order to obtain different organoleptic feature oil depending on the user.

The preservation of preserved frozen—vacuum-packed or not—olive paste as well as obtaining olive oil shall be easily performed at home and/or in industrial environments by means of the proper equipment for the emulsion and/or stirring of the paste and the centrifugation, decanting and/or pressing thereof.

A fourth example embodiment refers to the olive oil obtained from the preserved frozen and/or vacuum-packed paste hereof.

Within the context of this disclosure, acidity is one of the chemical characteristics which define oil quality. Thus, a high degree of acidity is abnormal in the oil produced by the breakage of the molecules of triglycerides through the ester bonds.

The degree of acidity of the oil represents the contents of free fat acids expressed as a percentage of the oleic acid.

Within the context of this disclosure, the peroxide index (PI) is a parameter of oil quality. It assesses the state of oxidation of the oil. During oil oxidation, the hyper oxides transfer to other substances, and this index also indicates the damage that might have been suffered by certain components such as α-tocopherols (Vitamin E) and polyphenols. The peroxides result from the existent oxidation in a sample at a certain time, and they are the first products of fat oxidation. This index measures the primary degree of oxidation of the oil, that is, the content of hyper oxides, and it indicates the state of preservation thereof. The peroxide index detects oil oxidation before it is organoleptically detected, in spite of its variability and low representation in respect to the global oxidation state of oil together with the photomethcal spectrum under UV light (K₂₃₂ and K₂₇₀) parameters that also indicate the state of oxidation of the oil, that is, from the beginning of oxidation until the time of rancidity.

The median of the peroxide index is based on the determination of the quantity of peroxides that are present in the samples (“meq” of active O₂/kg of oil) that cause the oxidation of potassium iodide under working conditions.

Within the context of this disclosure, the UV test gives indications about the oil quality, its state of preservation, and the changes induced by technological processes (such as refining). The absorptions at these wavelengths are due to the fact that there are conjugated dienes are measured at 232 nm, and conjugated trienes at 270 nm. These absorption values are expressed in specific extinction, conventionally as K, called coefficient of extinction. This method provides a first impression about the olive oil freshness.

Within the context of this disclosure, the applicable limits to determine the oil quality are those shown in Regulation EEC No. 2568/91, modified by Regulation (EC) No. 1989/2003 that states a value of acidity lower than 0.8%, the peroxide index with a maximum of 20 mEq O₂/kg, and 0.22 and 2.5 for the absorption at 270 nm and 232 nm, respectively, in extra virgin olive oils. For virgin olive oils, the maximum limit of acidity is 2%, and the absorption at 270 nm is 0.25 and 2.6 for 232 nm. The peroxide index is equal to 20 mEq O₂/kg.

Within the context of this disclosure and in relation to the sensory data shown in the examples (Tables IV and VI), the oil is classified under the denominations stated below, depending on the median defects and the median <<fruited>> (fruity) attribute. The median defect is the median of the negative attributes detected with more intensity.

The value of the solid variation coefficient for this negative attribute must be equal to or lower than 20%.
a) Extra virgin olive oil: the median defect is equal to 0, and that corresponding to the <<fruited>> attribute is higher than 0.
b) Virgin olive oil: the median defect is higher than 0 and less than or equal to 2.5, and that corresponding to the <<fruited>> attribute is higher than 0.
c) Most pure olive oil: the median defect is higher than 2.5 or lower than or equal to 2.5 and that corresponding to the <<fruited>> attribute is equal to 0.

Within the context of this disclosure and in relation to the specific vocabulary that has been developed for virgin oil sensory descriptors (IOOC, 1987; IOOC, 1996) the positive attributes of virgin olive oil are explained as:

Fruity (fruited): the basic positive attribute of virgin olive oil, characteristic of oil from healthy, fresh fruits, either ripe or unripe. The aroma of the oil from unripe olives is generally characterised by grassy or leafy attributes, whereas virgin olive oil from ripe fruits is characterised by aromatic flavours (IOOC, 1987).

Bitter: the primary taste produced by dilute aqueous solutions of various substances such as quinine, caffeine and many alkaloids. It is the characteristic taste of olive oil from olives that are green or turning colour (IOOC, 1987).

Pungent: the biting tactile sensation characteristic of oils produced at the start of the crop year, primarily from olives that are unripe (IOOC, 1987).

The common defects of sensory quality of the oil are described using the vocabulary below:

Fusty (accumulate olives): a characteristic flavor of oil from olives stored in piles of notable thickness or in jute sacks for long periods before extraction and undergoing an advanced stage of anaerobic fermentation. This is a common defect, especially with small processing plants that lack sufficient fruit storage space (IOOC, 1996). The total quantity of volatile compounds is high in fusty oil, with esters and acids contributing significantly to the fusty perception (Morales et al., 2005).

Musty-humid: a characteristic flavor of oils from fruit infested with large numbers of fungi and yeast as a result of storage at low temperature and high humidity. Fungi have the ability to oxidise free fatty acids to volatile compounds such as 2-heptanone and 2-nonanone. On the other hand, yeasts readily reduce carbonyl compounds (IOOC, 1996; Morales et al., 2005).

Muddy sediment: a characteristic flavor of oil that has been left in contact with the sediment for a long time (IOOC, 1996).

Winey-vinegary: a flavor mainly due to the process of fermentation in the olives, leading to the formation of acetic acid, ethyl acetate and ethanol. It is a flavor reminiscent of wine or vinegar (IOOC, 1996; Morales et al., 2005).

Rancid: a flavor of oils that have undergone oxidation. The main contributors are unsaturated aldehydes (IOOC, 1996; Morales et al., 2005).

Throughout the description and the claims, the word “comprise” and its variants is not intended to exclude other technical characteristics, additives, components or steps. For those skilled in the field, other objects, advantages and characteristics of the invention will become apparent from the disclosure.

The invention will now be described in more detail by way of examples. The following examples are for illustrative purposes only and are not intended, nor should they be interpreted, to limit the scope of the invention.

### EXAMPLES

### Example 1

### Feasibility Study

In order to perform this example, the feasibility of preserving olive and/or olive paste to obtain olive oil immediately before consumption was studied. In order to achieve this objective, the following experiment was planned for each olive variety:
Whole olive preservation (refrigerated and frozen)
Olive paste preservation (refrigerated and frozen). In order to obtain the paste, the olives were washed and the leaves removed; they were then ground to obtain a homogeneous paste. Then, part of that paste was refrigerated at an approximate temperature of 5° C., and another part of the paste was preserved frozen at an approximate temperature of −18° C.
Follow-up with control of the oil obtained from the paste and other preservation methods.
Analytical control of the oil obtained through the peroxide index and that of dienes and trienes.

The oil was first prepared to control its evolution over time, preserving it at ambient temperature, refrigerated, and frozen.

### Example 2

### Evolution of Analytical and Sensory Parameters of the Arbequina

The activities performed up to the one-month control for this variety were:
The acquisition of Arbequina olives at the Salomó Cooperative Association (Tarragona).
Obtaining of oil and olive paste for study. In order to do so, oil was initially prepared from the Arbequina olives, the said oil was preserved at ambient temperature in order to control its evolution as time went by, and the whole olives and the paste were preserved (refrigerated and frozen).
Analytical control of initial oil
Obtaining of oil from the olives and paste preserved after a month of treatment and on the third month
Analytical control and taste of the obtained oils.

The first control of the oil at ambient temperature after its extraction was performed and the following values obtained:
Peroxide Index=5.8 meq/Kg (S=0.4 meq/Kg; RSD=6.7%) and
Total acidity=0.20 g oleic acid/100 g oil

The sensory analysis of this oil did not show any defects.

The second control of oil was performed one month after the first. Table I below shows the analytical results obtained:

TABLE I

| | Parameter | | | | |
|---|---|---|---|---|---|
| | Total | | | | |
| | acidity | | | | |
| | (g oleic | Peroxide | Index | | |
| | acid/ | Index (meq | K₂₇₀ | Diene | Triene |
| Type of | 100 g) | O₂/kg) | *Max. | Index | Index |
| Treatment | *Max. 0.8 | *Max. 20 | 0.22 | μmol/g | μmol/g |
| Frozen preserved | n.d. | 5.1 | n.d. | 4.9 | 0.6 |
| oil | | | | | |
| Refrigerated | n.d. | 5.6 | n.d. | 5.1 | 0.6 |
| preserved oil | | | | | |
| Oil preserved at | 0.20 | 5.9 | 0.09 | 5.5 | 0.4 |
| ambient | | | | | |
| temperature | | | | | |
| Oil obtained from | 0.67 | 5.3 | 0.09 | 5.2 | 0.5 |
| refrigerated | | | | | |
| preserved olives | | | | | |
| Oil obtained from | 0.22 | 3.6 | 0.07 | 4.5 | 0.4 |
| frozen preserved | | | | | |
| olives | | | | | |
| Oil obtained from | 0.17 | 3.0 | 0.08 | 4.6 | 0.4 |
| frozen preserved | | | | | |
| olive paste | | | | | |

The “Max” values stated in the Table correspond to the extra virgin olive oil. In the case of virgin olive oil these values are the following maximum acidity 2.0. K270 maximum 0.25.
n.d. non-determined

The third control was performed after three months of the first control, the fourth control at six months, and the fifth control at 12 months.

In Table II below, there is a summary of the evolution of analytical parameters during the first year for the Arbequina:

TABLE II

| | | | | | | Control |
|---|---|---|---|---|---|---|
| | | Initial | Control | Control | Control | 12 |
| Parameter | ARBEQUINA Oil | Control | 1 month | 3 months | 6 months | months |
| Total | Oil preserved at | 0.20 | 0.20 | 0.22 | 0.21 | 0.25 |
| acidity | ambient temperature | | | | | |
| (g oleic | Oil observed from | 0.20 | 0.17 | 0.22 | 0.18 | 0.20 |
| acid/ | preserved frozen olive | | | | | |
| 100 g) | paste | | | | | |
| *Max. 0.8 | Oil obtained from | 0.20 | 0.07 | 1.21 | — | — |
| | preserved refrigerated | | | | | |
| | olives | | | | | |
| | Oil obtained from | 0.20 | 0.22 | 0.23 | — | — |
| | preserved frozen olives | | | | | |
| Peroxide | Oil preserved at | 5.8 | 5.9 | 6.4 | 6.80 | 10.3 |
| Index | ambient temperature | | | | | |
| (meq O₂/kg) | Oil obtained from | 5.8 | 3.0 | 3.9 | 3.25 | 3.45 |
| *Max. 20 | preserved frozen olive | | | | | |
| | paste | | | | | |
| | Oil obtained from | 5.8 | 5.3 | 3.1 | — | — |
| | preserved refrigerated | | | | | |
| | olives | | | | | |
| | Oil obtained from | 5.8 | 3.6 | 2.1 | — | — |
| | preserved frozen olives | | | | | |
| Index | Oil preserved at | n.d | 0.09 | 0.10 | 0.10 | 0.13 |
| K₂₇₀ | ambient temperature | | | | | |
| *Max.0.22 | Oil obtained from | n.d | 0.08 | 0.07 | 0.10 | 0.10 |
| | preserved frozen olive | | | | | |
| | paste | | | | | |
| | Oil obtained from | n.d | 0.09 | 0.10 | — | — |
| | preserved refrigerated | | | | | |
| | olives | | | | | |
| | Oil obtained from | n.d | 0.07 | 0.07 | — | — |
| | preserved frozen olives | | | | | |

The “Max” values stated in the Table correspond to the extra virgin olive oil. In the case of virgin olive oil these values are the following: maximum sourness 2.0. K270 maximum 0.25. n.d. non-determined

Once, the third (3 months) and fourth (6 months) control were performed, the hedonic tasting of the oils obtained through different treatments, i.e. from the frozen paste, the refrigerated olives, and the frozen olives, was performed by an expert from the La Garriga (Lleida) area who remarked that the best oil was that obtained from the frozen paste and who detected a defect called dead olive aroma in the oil obtained from the frozen olives. Tables III and IV show the results obtained from this tasting:

TABLE III

| Type of Treatment | Description |
|---|---|
| Oil preserved at ambient | The worst compensated |
| temperature | |
| Oil obtained from preserved | Better colour, fair smell |
| refrigerated olives | |
| Oil obtained from preserved | Inadequate colour, good taste, no smell |
| frozen olives | |
| Oil obtained from preserved | Better compensated, taste, smell and colour |
| frozen olive paste | |

The sensorial analysis showed in Tables IV nd VI were made by the Panell de Tast Oficial d'Olis Verges d'Oliva de Catalunya.

TABLE IV
Variety Arbequina

| | Control | | | | | | | | | | | | | |
|---|---|---|---|---|---|---|---|---|---|---|---|---|---|---|
| | | | Time: one | | | | | | | | Time: 6 | | | |
| | | | month of oil | | Time: one | | Time: 3 months | | | | months of oil | | Time: 6 | |
| | | | preserved at | | month, oil | | of oil preserved | | Time: 3 months | | preserved at | | months oil | |
| | | | ambient | | from forzen | | at ambient | | oil from frozen | | ambient | | from frozen | |
| | | | temperature | | paste | | temperature | | paste | | temperature | | paste | |
| Taste | Time 0 | | AANF + 1 | | PCT1 | | AAFT3 | | APCT3 | | AAFTO6 | | APCT6 | |
| Reference | Intensity | DE | Intensity | DE | Intensity | DE | Intensity | DE | Intensity | DE | Intensity | DE | Intensity | DE |
| Positive | | | | | | | | | | | | | | |
| Attributes | | | | | | | | | | | | | | |
| Fruited | nd | nd | 3.2 | 0.7 | 3.6 | 0.9 | 5.4 | 0.5 | 3.5 | 0.4 | 3.1 | 1.7 | 2.2 | 0.2 |
| Bitter | nd | nd | 1.5 | 1.2 | 2.3 | 1.0 | 2.9 | 1.0 | 1.8 | 0.6 | 2.1 | 0.5 | 1.8 | 0.4 |
| Pungent | nd | nd | 2.7 | 0.5 | 2.9 | 0.8 | 4.2 | 0.2 | 3.4 | 0.5 | 3.1 | 0.6 | 2.8 | 1.3 |
| Sweetness | nd | nd | 4.8 | 0.3 | 4.7 | 0.5 | 4.2 | 0.9 | 4.5 | 0.4 | 4.4 | 0.4 | 5.1 | 0.5 |
| Defects | | | | | | | | | | | | | | |
| Winey- | nd | nd | 0.0 | 0.0 | 0.0 | 0.0 | 0.0 | 0.0 | 0.0 | 0.0 | 0.0 | 0.9 | 1.6 | 1.4 |
| vinegary | | | | | | | | | | | | | | |
| Mould/ | nd | nd | 0.0 | 0.0 | 0.0 | 0.0 | 0.0 | 0.0 | 0.0 | 0.0 | 0.0 | 1.2 | 2.9 | 2.5 |
| Humidity | | | | | | | | | | | | | | |
| Muddy | nd | nd | 0.0 | 0.0 | 0.0 | 0.0 | 0.0 | 0.0 | 0.0 | 0.0 | 0.0 | 0.0 | 0.0 | 0.0 |
| sediment | | | | | | | | | | | | | | |
| Fusty | nd | nd | 0.0 | 0.0 | 0.0 | 0.0 | 0.0 | 0.0 | 0.0 | 0.0 | 0.0 | 0.0 | 0.0 | 1.0 |
| Rancid | nd | nd | 0.0 | 0.0 | 0.0 | 0.0 | 0.0 | 0.0 | 0.0 | 0.0 | 0.0 | 0.0 | 0.0 | 0.0 |

### Example 3

### Evolution and Analytical and Sensory Parameters of Picual

The activities performed up to the control corresponding to the first month for this variety were:
The acquisition of Picual olives
Obtaining of Picual preserved frozen oil and olive paste for preservation study
Analytical and sensory control of initial oil
Analytical and sensory control of oils after the first month of control

The first control of Picual oil at ambient temperature after extraction was performed and the following values were obtained:

Peroxide Index=6.1 meq O₂/Kg oil (Maximum 20 meq O₂/Kg oil)
Index K₂₇₀=0.08 (Maximum 0.22)
Total acidity=0.30 g oleic acid/100 g oil

The sensory analysis of this oil has not shown any defects.

The second control of this oil was performed one month after the first control, the third one at 3 months, and the fourth one at 6 months.

Table V below shows the analytical results obtained:

TABLE V

| | Parameter | | |
|---|---|---|---|
| | Total acidity | | |
| | (g oleic | Peroxide Index | |
| | acid/100 g) | (meq O₂/kg) | Index K₂₇₀ |
| Type of Treatment | *Max. 0.8 | *Max. 20 | *Max.0.22 |
| Initial oil | 0.30 | 6.1 | 0.08 |
| Oil preserved at ambient | 0.36 | 6.5 | 0.09 |
| temperature - 1 month | | | |
| Oil obtained from preserved | 0.28 | 5.2 | 0.08 |
| frozen olive paste - 1 month | | | |
| Oil preserved at ambient | 0.32 | 10.1 | 0.09 |
| temperature - 3 month | | | |
| Oil obtained from preserved | 0.28 | 4.3 | 0.06 |
| frozen olive paste - 3 month | | | |
| Oil preserved at ambient | 0.30 | 9.3 | 0.13 |
| temperature - 6 month | | | |
| Oil obtained from preserved | 0.28 | 3.7 | 0.07 |
| frozen olive paste - 6 month | | | |

After the second control was performed, the hedonic tasting of the oils obtained using the different treatments was performed, the results of which are shown on Table VI below:

TABLE VI
Variety Picual

| | Control | | | | | |
|---|---|---|---|---|---|---|
| | | | Time: 1 | | | |
| | | | month - oil | | | |
| | | | preserved | | Time: 1 | |
| | Time 0 | | at ambient | | month - oil | |
| | FILTERED | | temperature | | from frozen paste | |
| | PICUAL | | PAFT1 | | PPCT1 | |
| Taste Reference | Intensity | DE | Intensity | DE | Intensity | DE |
| Positive Attributes | | | | | | |
| Fruited | 4.2 | 0.6 | 4.3 | 0.5 | 2.1 | 0.9 |
| Bitter | 3.0 | 0.4 | 2.1 | 1.7 | 2.0 | 0.0 |
| Pungent | 3.5 | 0.0 | 3.0 | 0.4 | 2.8 | 0.9 |
| Sweetness | 4.6 | 0.4 | 4.8 | 1.3 | 4.9 | 0.6 |
| Defects | | | | | | |
| Winey-vinegary | 0.0 | 0.0 | 0.0 | 0.0 | 1.6 | 1.1 |
| Mould/Humidity | 0.0 | 0.0 | 0.0 | 0.0 | 0.0 | 1.2 |
| Muddy sediment | 0.0 | 0.0 | 0.0 | 0.0 | 0.0 | 0.0 |
| Fusty | 0.0 | 0.0 | 0.0 | 0.0 | 1.5 | 1.5 |
| Rancid | 0.0 | 0.0 | 0.0 | 0.0 | 0.0 | 1.0 |

The results for Picual show a similar tendency to those already seen in example 2 for the Arbequina.

### REFERENCES

The following references are incorporated herein by reference in the entirety.
Angerosa, F., Basti, C, & Vito, R. (1999). Virgin olive oil volatile compounds from lipoxygenase pathway and characterization of someltalian cultivars. Journal of Agricultural and Food Chemistry, 47(3), 836-839.
Angerosa, F., Mostallino, R., Basti, C. & Vito, R. (2001). Influence of malaxation temperature and time on the quality of virgin olive oils. Food Chemistry 72: 19-28.
Campeol, E., Flamini, G., Chehconi, S., Catalano, S., & Cremonini, R. (2001). Volatile Compounds from three cultivars of olea europaea from Italy. Journal of Agricultural and Food Chemistry, 49(11), 5409-5411.
Clodoveo M. L, Delcuratolo D., Gomes T., CoIeIIi, G. (2007). Effect of different temperatures and storage atmospheres on Coratina olive oil quality. Food Chemistry 102: 571-576.
Garcia, J. M., Gutierrez, F., Barrera, M. J., & Albi, M. A. (1996). Storage of mill olives on an industrial scale. Journal of Agricultural and Food Chemistry, 44, 590-593.
Garcia, J. M., Gutierrez, F., Castellano, J. M., Perdiguero, S., & Albi, M. A. (1996). Influence of storage temperature on fruit ripening and olive oil quality. Journal of Agricultural and Food Chemistry, 44, 264-267.
EC (1997). Official Journal of the Commission of the European Communities, Regulation No. 2472/97, L341, December 12.
IOOC Sensory analysis: general basic vocabulary. In COI/T.20/Doc no. 4; 1987.
IOOC Organoleptic assessment of virgin olive oil. In COI/T.20/Doc no. 15; 1996.
Kalua C. M., Bedgood, D. R., Bishop, A. G. & Prenzler P. D. (2006). Discrimination of Storage Conditions and Freshness in Virgin Olive Oil. Journal of Agricultural and Food Chemistry, 54, 7144-7151.
Koprivnjak, O., Conte, L., & Totis, N. (2002a). Influence of olive fruit storage in bags on oil quality and composition of volatile compounds. Food Technology and Biotechnology, 40(2), 129-134.
Koprivnjak, O., Procida, L., & Zelinotti, N. (2002b). Changes in the volatile components of virgin olive oil during fruit storage in aqueous media. Food Chemistry 70: 377-384.
Luna, G., Morales, M. T. & Aparicio, R. (2006). Changes Induced by UV Radiation during Virgin Olive Oil Storage. Journal of Agricultural and Food Chemistry, 54 (13), 4790-4794.
Mendez A. I. & Falque E. (2007). Effect of storage time and container type on the quality of extra-virgin olive oil. Food Control 18, 521-529.
Morales, M. T., Luna, G., & Aparicio, R. (2005). Comparative study of virgin olive oil sensory defects. Food Chemistry, 91 (2), 293-301.
Pereira, J. A., Casal, S., Bento, A., & Oliveira, M. B. P. P. (2002). Influence of olive storage period on oil quality of three Portuguese cultivars of Olea europea, Cobrangosa, Madural, and Verdeal Transmontana. Journal of Agricultural and Food Chemistry, 50(22), 6335-6340.
Sabatini, N. & Marsilio, V. (2007). Volatile compounds in table olives (Olea Europaea L, Nocellara del Belice cultivar) Food Chemistry (in press).
Tawfik M. S. & Huyghebaert, A. (1999). Interaction of packaging materials and vegetable oils: oil stability. Food Chemistry 64:451-45.
Venkateshwarlu, G., Let, M. B., Meyer, A. S., & Jacobsen, C. (2004). Modeling the sensory impact of defined combinations of volatile lipid oxidation products on fishy and metallic off-flavors. Journal of Agricultural and Food Chemistry, 52(6), 1635-1641.
Visioli, F.; Galli, C. (1998). Olive oil phenols and their potential effects on human health. Journal of Agricultural and Food Chemistry, 46, 4292-4296.
Zamora, R., Alaiz, M. & Hidalgo, F. J. (2001). Influence of Cultivar and Fruit Ripening on Olive (Olea europaea) Fruit Protein Content, Composition, and Antioxidant Activity. Journal of Agricultural and Food Chemistry, 49, 4267-4270.

Having sufficiently described the nature of the various example embodiments, it should be stated that the aforementioned embodiments may have their details modified provided it does not alter the fundamental principle.

The invention is, of course, not limited to the examples described but cover all the variants defined in the claims. The terms “a” and “an” and “the” and similar references used in the context of the following claims are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g. “such as”) provided herein is intended merely to better illuminate the embodiments and does not pose a limitation on the scope of the embodiments otherwise claimed. No language in the specification should be construed as indicating any non-claimed element essential to the practice of the embodiments.

The use of the term “or” in the claims is used to mean “and/or” unless explicitly indicated to refer to alternatives only or the alternatives are mutually exclusive, although the disclosure supports a definition that refers to only alternatives and “and/or.” Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments are described herein, including the best mode known to the inventors for carrying out the invention. Of course, variations on those preferred embodiments will become apparent to those of ordinary skill in the art upon reading the foregoing description. The inventors expect those of ordinary skill in the art to employ such variations as appropriate, and the inventors intend for the embodiments to be practiced otherwise than specifically described herein. Accordingly, these embodiments include all modifications and equivalents of the subject matter recited in the claims appended hereto as permitted by applicable law. Moreover, any combination of the above-described elements in all possible variations thereof are encompassed by the embodiments unless otherwise indicated herein or otherwise clearly contradicted by context.

Further, it is to be understood that the example embodiments disclosed herein are illustrative. Other modifications that may be employed are within the scope of the embodiments. Thus, by way of example, but not of limitation, alternative configurations of the present embodiments may be utilized in accordance with the teachings herein. Accordingly, the present embodiments are not limited to that precisely as shown and described.

1-11. (canceled)

12. A method for preserving olive oil comprising freezing the paste obtained from olive grinding.

13. The method of claim 12 further comprising vacuum packing the obtained olive paste.

14. A method for preserving olive oil comprising freezing the paste directly obtained from olive grinding, prior to malaxation, at a temperature from about 0° C. to about −40° C.

15. The method of claim 12, wherein the range of temperatures use for freezing the obtained paste is from about 0° C. to about −22° C.

16. The method of claim 15, wherein the range of temperatures use for freezing the obtained paste is from about −5° C. to about −18° C.

17. The method of claim 16, wherein the range of temperatures use for freezing the obtained paste is from about −7° C. to about −10° C.

18. Olive paste obtained by the method for preserving olive oil of claim 12.

19. Olive paste obtained by the method for preserving olive oil of claim 17.

20. A process to obtain olive oil from the olive paste of claim 19 comprising:
at least one of emulsifying and stiffing the olive paste;
extracting the olive oil through centrifugation; and
separating the aqueous phase from the oleous phase through decanting.

21. The process of claim 20 further comprising pressing the product of said step of at least one of at least one of emulsifying and stirring the olive paste.

22. Olive oil obtained by the process of claim 20.

23. Olive oil obtained by the process of claim 21.

24. The method of claim 14, wherein the range of temperatures use for freezing the obtained paste is from about 0° C. to about −22° C.

25. The method of claim 24, wherein the range of temperatures use for freezing the obtained paste is from about −5° C. to about −18° C.

26. The method of claim 25, wherein the range of temperatures use for freezing the obtained paste is from about −7° C. to about −10° C.

27. Olive paste obtained by the method for preserving olive oil of claim 14.

28. Olive paste obtained by the method for preserving olive oil of claim 26.

29. A process to obtain olive oil from the olive paste of claim 28 comprising:
at least one of emulsifying and stiffing the olive paste;
extracting the olive oil through centrifugation; and
separating the aqueous phase from the oleous phase through decanting.

30. The process of claim 29 further comprising pressing the product of said step of at least one of at least one of emulsifying and stirring the olive paste.

31. Olive oil obtained by the process of claim 29.

32. Olive oil obtained by the process of claim 30.
